(19) United States
(12) Patent Application Publication
(10) Pub. No.: US 2005/0082813 A1
(43) Pub. Date: Apr. 21, 2005

(54) Door scuff trim fixing structure of a vehicle

(76) Inventor: Chang Mo Seong, Suwon-city (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/747,909

(22) Filed: Dec. 29, 2003

(30) Foreign Application Priority Data
Oct. 17, 2003 (KR) 10-2003-0072592

(51) Int. Cl. B62D 21/00

(52) U.S. Cl. 280/782

(57) ABSTRACT

A side sill, door scuff trim, and wiring harness are efficiently interconnected by an integral clip. This includes a main body for receiving the wiring harness, a lower body firmly attachable to the side sill, and a cover for covering the wire receiving hole.

### CROSS REFERENCE TO RELATED APPLICATIONS

This application claims priority to Korean Application No.10-2003-0072592, filed on Oct. 17, 2003, the disclosure of which is incorporated fully herein by reference.

### FIELD OF THE INVENTION

Generally, the present invention relates to a door scuff trim fixing structure for a vehicle.

### BACKGROUND OF THE INVENTION

In general, door scuff trim is installed near a vehicle door opening. The door scuff trim is typically positioned on an upper part of the door opening side sill such that floor wires are protected from where passengers step while entering or exiting the vehicle.

A typical clip for fixing the door scuff trim includes a clip with an end fixed to a side sill inner panel by a fixing device such as a screw. Holding members are then generally formed facing each other at the other end of the clip such that an insertion area is formed between the holding members. A supporting member is then often formed lower than the insertion area.

The door scuff trim has a fixing member integrally formed therewith at its end. The fixing member is inserted into the insertion area of the clip. An end of a horizontal portion of the door scuff trim is supported by a body weather strip mounted on a flange of the side sill. A vertical portion of the door scuff trim is thereafter connected to the vehicle's carpet.

Eight clips are typically used for assembling front and rear door scuff trims. When including auxiliary hardware, a total of sixteen parts are therefore needed. Therefore, assembly of this region of the vehicle can be lengthy. When a wiring harness is mounted having the clips mounted thereon, the clips easily slip toward the interior of the vehicle, which deteriorates assembly quality, further causing an increase in manufacturing cost. Therefore, what is needed is a clip that is easily installed and simple to manufacture and use.

The information disclosed in this Background of the Invention section is only for enhancement of understanding of the background of the invention and should not be taken as an acknowledgement or any form or suggestion that this information forms the prior art that is already known in this country to a person of ordinary skill in the art.

### SUMMARY OF THE INVENTION

The present invention provides a door scuff trim fixing structure for a vehicle having a reduced number of required parts and, accordingly, a reduced vehicle manufacturing cost.

According to an embodiment of the present invention the door scuff trim includes a side sill, a clip, door scuff trim, and a wiring harness. The side sill of a vehicle door opening has an opening formed thereon. The clip includes a main body, a lower body, and a cover. The main body has a wire receiving hole at an interior and engaging areas formed upward at both sides of the wire receiving holes. The lower body has an extension portion extending downward from the main body and has fixing members formed at both sides of the extension portion. The fixing members are engaged with the opening of the side sill. The cover covers the wire receiving hole and an end of the cover is attached to the main body. The other end of the cover swings to cover the wire receiving hole.

The door scuff trim is disposed above the clip and has a plurality of protrusions at a lower side of a horizontal portion. The protrusions are engaged with the engaging areas of the lower body of the clip. The wiring harness is inserted into the wire receiving hole and covered by the cover.

In a further embodiment, a catching projection is formed at each of the engaging area of the main body and the protrusion of the door scuff trim.

### BRIEF DESCRIPTION OF THE DRAWINGS

The accompanying drawings, which are incorporated in and constitute a part of the specification, illustrate an embodiment of the invention, and, read together with the description, serve to explain the principles of the invention in which:

FIG. 1 is a perspective view of a clip for fixing door scuff trim of a vehicle according to an embodiment of the present invention;

FIG. 2 is a sectional view taken along line A-A of FIG. 1; and

FIG. 3 is a sectional view of a door scuff trim fixing structure of a vehicle including a clip according to an embodiment of the present invention.

### DETAILED DESCRIPTION OF PREFERRED EMBODIMENTS

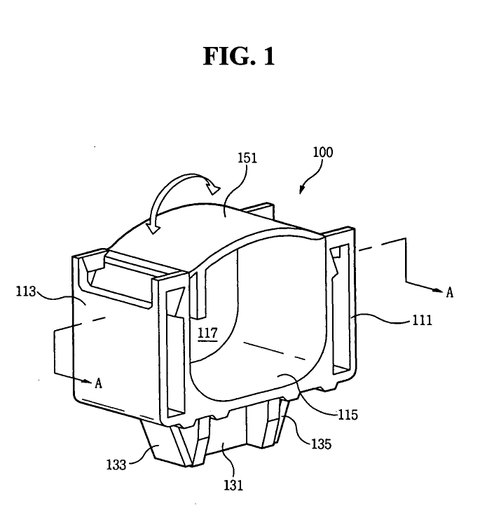

FIG. 1 is a perspective view of a clip for fixing a door scuff trim of a vehicle showing a clip 100 including a main body 110, a lower body 130, and a cover portion 150. A wire receiving hole 117 is formed near a center of the main body 110 and at both sides of the receiving hole 117. Engaging areas 114 and 115 are formed upward for holding the door scuff trim. The lower body 130 extends downward from the main body 110 and has fixing members 133 and 135 formed at both sides.

The cover portion 150 extends upward from the main body 110 and an open end of the cover portion 150 can engage with the main body 110 such that the wire receiving hole 117 can be covered. The wire receiving hole 117 is approximately U-shaped. Each of side portions 111 and 113 extend from the main body 110. The engaging areas 115 and 114 are, respectively, formed above the extended portions 111 and 113. Inside the engaging areas 115 and 114, catching projections 111b′ and 113b′ are formed to catch an engaging object.

The lower body 130 extends downward from the main body 110. A width of the lower body 130 is smaller than a width of a lower portion of the main body 110. At both sides of the extended portion (i.e., the lower body 130), fixing members 133 and 135 are formed for engagement with a side sill inner panel.

The cover portion 150 includes a cover member 151. An end of the cover member 151 is attached to the main body 110 and another end swings at a center of the attached end, such that, it covers the wire receiving hole 117.

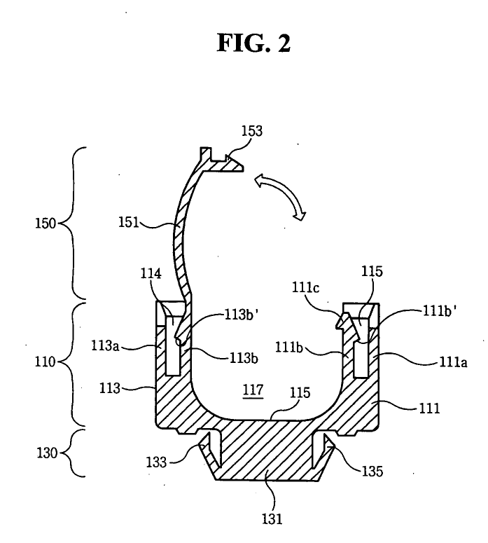

Operation of an embodiment having such a clip 100 is hereinafter described. As shown in FIG. 2, the clip 100 is engaged with an opening of the side sill inner panel. A floor wiring harness 160 is inserted into the wire receiving hole 117 of the clip 100 and then the cover member 151 is closed to cover the wiring harness 160. A catching projection 153, formed at an end of the cover member 151, engages with and becomes firmly held by a catching member 111c formed at an upper end of the main body 110.

The door scuff trim 30 is disposed above the clip 100 having the cover member 151 closed. Protrusions 34 and 35, formed under a horizontal portion 32 of the door scuff trim 30, are inserted to the engaging areas 114 and 115 and held therein.

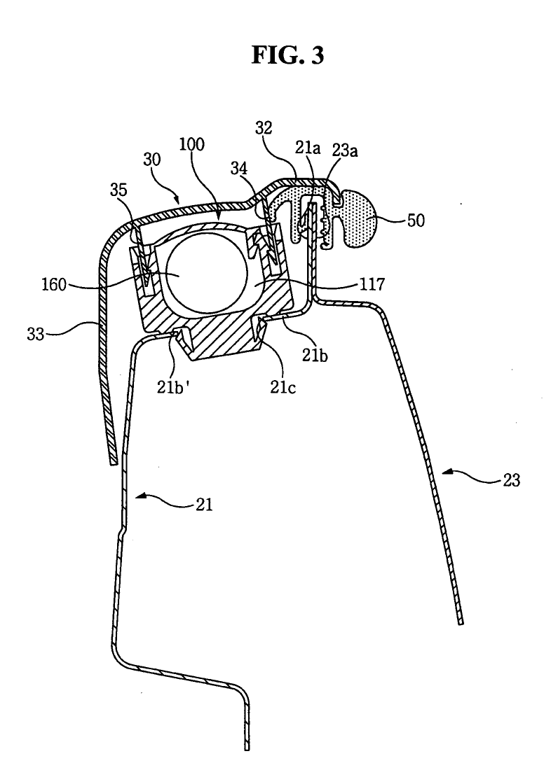

The lower body 130 of the clip 110 is engaged with the side sill inner panel 21 by fixing member 133 and 135 formed at both sides of the lower body 130. In more detail, as shown in FIG. 3, a hole or opening 21c is formed on the side sill inner panel 21 in a size such that the lower body 130 can be inserted thereto. A circumference of the hole 21c is engaged with the fixing members 133 and 135. A flange 21a of the side sill inner panel 21 and a flange 23a of the side sill outer panel 23 are both fixed with a body weather strip 50. An end of the horizontal portion 32 of the door scuff trim 30 is laid above the body weather strip 50.

Accordingly, in order to fix the door scuff trim 30 using the clip 100, the clip is firstly fixed to a vehicle body. The wiring harness 160 is them inserted into the wire receiving hole 117 of the main body 110 and the cover member 151 is closed to fix it. Subsequently, the door scuff trim 30 is fixed to the vehicle body by inserting the protrusions 34 and 35 under the door scuff trim 30 into the engaging areas 114 and 115 of the main body 110. The lower body 130 is firmly held to the side sill inner panel 21 by the fixing members 133 and 135. The protrusions 34 and 35 are integrally formed to the trim 30 and have a predetermined spacing therebetween. Catching projections are formed at ends of the protrusions 34 and 35 such that the protrusions 34 and 35 can be firmly held when inserted into the engaging areas 114 and 115. Two protrusions, 34 and 35, are exemplarily and shown in the drawings as correspondingly to the two engaging areas 114 and 115.

As described above, a clip used for fixing door scuff trim according to an embodiment of the present invention includes a main body having a wire receiving hole at an interior thereof and having engaging areas formed upward at both sides of the wire receiving holes. A lower body has fixing members for being engaged with the opening of the side sill and a cover for covering the wire receiving hole. Therefore, a wiring harness can be fixed to a vehicle body using such an integral unit clip. Furthermore, the door scuff trim and a side sill inner panel are easily interconnected without using extra fastening members such as screws.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

1. A door scuff trim fixing structure of a vehicle, comprising:
a side sill of a vehicle having an opening formed thereon;
a clip comprising:
a main body having a wire receiving hole at an interior thereof and having engaging areas formed upward at both sides of the wire receiving holes;
a lower body having an extension portion extending downward from the main body and having fixing members formed at both sides of the extension portion, the fixing members being engaged with the opening of the side sill; and
a cover for covering the wire receiving hole, an end of the cover being attached to the main body, another end of the cover swinging for covering the wire receiving hole;
door scuff trim disposed above the clip, the door scuff trim having a plurality of protrusions at a lower side of a horizontal portion thereof, the protrusions being engaged with the engaging areas of the lower body of the clip; and
a wiring harness inserted into the wire receiving hole and covered by the cover.

2. The door scuff trim fixing structure of a vehicle of claim 1, wherein a catching projection is formed at each of the engaging area of the main body and the protrusion of the door scuff trim.

3. A door scuff trim fixing structure of a vehicle, comprising:
a clip comprising:
a main body defining a wire receiving hole near an interior thereof and having engaging areas formed upward near both sides of the wire receiving hole;
a lower body having an extension portion extending downward from the main body and having fixing members formed near both sides of the extension portion;
a cover for covering the wire receiving hole, the cover having at least two ends, wherein one end of the cover being attached to the main body and another end of the cover swinging for covering the wire receiving hole.

4. The door scuff trim fixing structure of claim 3, wherein a catching projection is formed at each of the engaging areas of the main body.

5. The door scuff trim fixing structure of claim 3, further comprising a wiring harness inserted into the wire receiving hole and covered by the cover.
